(19) United States
(12) Patent Application Publication
(10) Pub. No.: US 2019/0234142 A1
(43) Pub. Date: Aug. 1, 2019

(54) CHAIN FOR A SCREEN DEVICE

(71) Applicant: Auto-Motion Shade Inc., Markham (CA)

(72) Inventor: Hans GRÜTZNER, Kehrsatz (CH)

(21) Appl. No.: 16/260,619

(22) Filed: Jan. 29, 2019

(30) Foreign Application Priority Data
Jan. 29, 2018 (EP) 18153821.6

(51) Int. Cl. E06B 9/54; E06B 9/262

(52) U.S. Cl. CPC E06B 9/54; E06B 9/262

(57) ABSTRACT

The chain consists of a plurality of rigid chain links and of a flexible traction means that connects the chain links. Said flexible traction means is a ball string that consists of a string and of balls arranged thereon at intervals, and said balls are pressed into openings of said chain links.

### BACKGROUND OF THE INVENTION

The invention relates to a chain for a screen device, consisting of a plurality of rigid chain links and of a flexible traction means that connects the chain links.

On openings such as windows or doors of fixed or mobile facilities for living, work, or storage, various screen devices such as shades, privacy screens, light scattering screens, or insect screens are used. To this end, the opening is covered or uncovered, respectively, by a mostly textile fabric that is folded or wound up between a fixed end profile and a movable end profile. Orthogonally to the mentioned end profiles, guiding profiles for the textile fabric and the movable end profile are arranged. To prevent canting of the movable end profile during its movement and to ensure that it is guided in parallel to itself, its ends are coupled to each other by flexible means that are deflected via rollers or pins. Depending on the construction type of the screen device, these flexible means have to transmit not only tensile but also pressure forces in some areas. Therefore, these areas are designed as chains having articulated chain links.

From the prior art, two different ways of connecting the chain links to each other are known, namely by strings, ribbons or the like, or by a kind of hinge having bolts or prolongations arranged on the chain links which engage in recesses provided in the adjacent chain link. The reference EP1640554 shows both types, i.e. the connection of the chain links by means of strings in FIG. 4B and by means of hinges in FIG. 12B. Further examples of connecting the chain links by strings are found in JP2014088736A and EP1959090B1. The reference EP1826356A2 shows an example where the chain links are arranged on a ribbon. References showing the connection of the chain links by hinges are WO2013/015689A1, DE69900343T3, EP1653038B1, EP1905944B1, EP2034123B1, EP2305942B1, and EP2681393B1.

If the chain links are connected by strings or ribbons, the chain links have to be either threaded onto the strings or ribbons and fixed with respect to the strings or ribbons, or the strings or ribbons are molded in during the manufacture of the chain links by injection molding from plastics. If the chain links are connected by hinges, each individual chain link has to be positively connected to an adjacent chain link while parts of the chain links are elastically deformed, or a hinge pin is inserted into two adjacent chain links. All these manufacturing procedures are relatively laborious and make the chains comparatively expensive.

### SUMMARY OF THE INVENTION

On the background of this prior art, it is the object of the invention to suggest a chain for a screen device that is simple and cost-efficient to manufacture.

According to the invention, this object is achieved by a chain for a screen device wherein said flexible traction means is a ball string that consists of a string and of balls arranged thereon at intervals, wherein said balls are received in openings of the chain links, and wherein two opposite, unilaterally open slots are provided in the circumference of each opening.

The term “ball string” used in claim 1 is commonly used for a driving means in the field of roller or venetian blinds and designates a flexible string with balls fastened thereto at intervals. Sometimes the term “ball string driving belt” is used. An example of an endless ball string is described in the reference DE3814704A1. In contrast to this example, the ball string of the present invention is not necessarily endless.

Due to the design of the invention, the chain is easy to assemble and disassemble.

### BRIEF DESCRIPTION OF THE DRAWINGS

Exemplary embodiments of the invention will be explained hereinafter with reference to the attached drawings showing

FIG. 1 a perspective view of a chain during assembly;

FIG. 2 a perspective view of a finished chain in the bent condition;

FIG. 3 a perspective view of an individual chain link;

FIG. 4 an elevation of the chain link of FIG. 3; and

FIG. 5 a section view along line V-V in FIG. 4 of the same chain link.

### DETAILED DESCRIPTION OF THE INVENTION

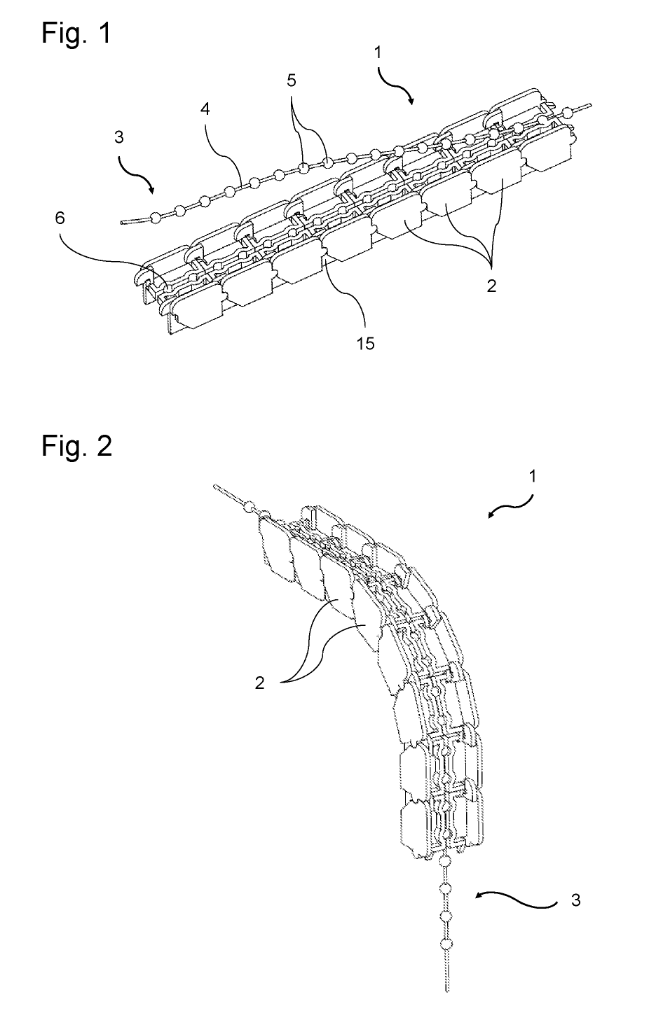

Chain 1 shown in a perspective view in FIG. 1 consists of rigid chain links 2 lined up in mutual contact, which are held together by a ball string 3. The latter consists of a string 4 that may be in the form of a mono or multifilament and on which balls 5 are fastened at regular intervals. FIG. 1 shows a situation where chain 1 is being assembled. To this end, the chain links are lined up as shown, e.g. on a non-represented auxiliary device in the form of a guide rail. First, a ball 5 is manually pressed into an opening 6 of chain link 2 arranged at the far right of the Figure and ball string 3 is positioned above the following chain links 2 as shown. Subsequently, balls 5 are successively pressed into respective openings 6 from the left to the right in the Figure, e.g. by means of a non-represented roller. Providing two or more openings 6 per chain link 2 not only improves the connection between ball string 3 and chain links 2 due to the adhesion of balls 5 in openings 6, but it is also possible to lengthen a chain by an additional ball string section in that one and the same chain link 2 receives a respective ball 5 of two separate ball string sections.

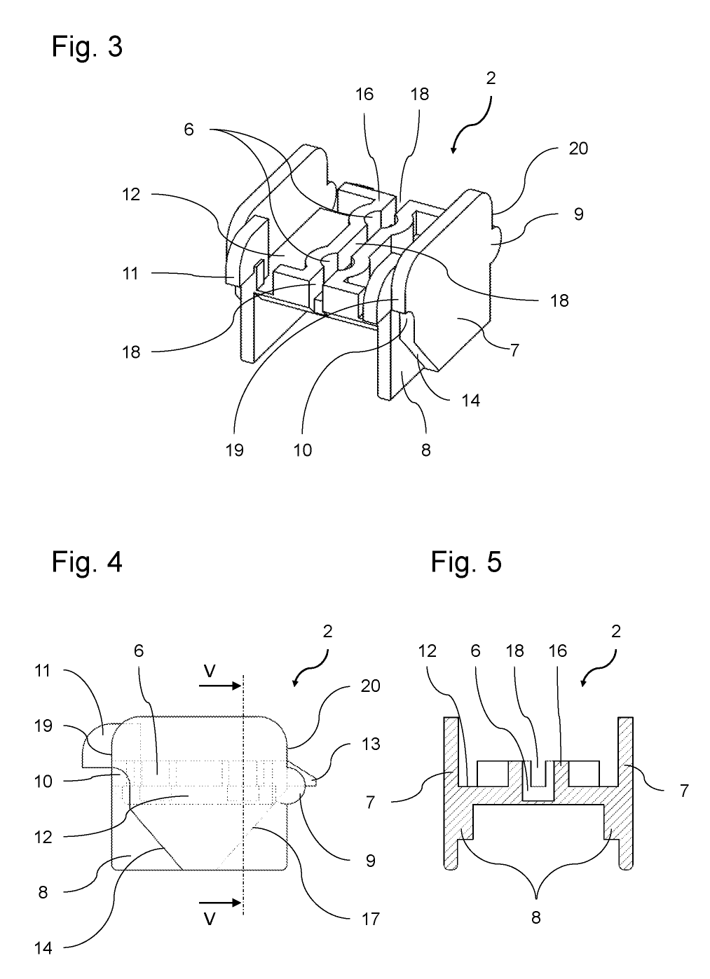

An important aspect of the chain described and illustrated by way of example is demonstrated in FIG. 2. Chain 1 is designed so as to be able to be deflected e.g. in the frame of a window, i.e. to be bent in a direction as depicted in FIG. 2. In the opposite direction, i.e. in the direction of ball string 3, however, chain 1 is relatively rigid so as to guide and support a textile fabric, e.g. an insect screen, in an opening such as a window without buckling in the direction of the window opening under a pressure load. How this is achieved will become apparent from the following description of FIGS. 3 to 5.

FIG. 3 shows an individual chain link 2 in a perspective view that is enlarged with respect to FIG. 1, and FIGS. 4 and 5 show the same chain link 2 in an elevation and in a sectional view along line V-V in FIG. 4, respectively. Chain link 2 is e.g. manufactured from a plastics material by injection molding and substantially consists of two parallel side walls 7 that are connected to each other by a web 12 so that the H shape shown in FIG. 5 results. Web 12 has a raised portion 16 in which two openings 6 are formed, on one hand, and slots 18, on the other hand. The two openings 6 serve for receiving respective balls 5 of ball string 3, the diameter of each opening 6 being chosen such that ball 5 is held therein with a press fit. Alternatively or additionally, opening 6 might have an undercut so that ball 5 snaps in when pressed in. Slots 18 accommodate string 4 of ball string 5 in the assembled condition of chain 1.

Alternatively or additionally to the arrangement of openings 6 shown in the Figures, openings might be arranged in the two edge areas of chain link 2 to which another chain link adjoins in such a manner that a respective ball comes to lie between two adjacent chain links.

For the purposes of the following description, the position of chain link 2 shown in FIGS. 1 and 3 will be used as a reference for the terms front, rear, top, bottom, left, and right. It is understood that this position may change when chain 1 is in use in a non-represented screen device. On the front side of chain link 2, each of the side walls 7 arranged on the left and on the right has a semi-circular protrusion 9. On the inside of each side wall 7, chain link 2 has a projection 8 that extends beyond side wall 7 at the rear and has an upper overhang 11. Furthermore, the rear portion of each side wall 7 has a concave rounded portion 10 into which the semi-circular protrusion 9 of a rearwardly adjoining chain link 2 fits and therewith forms a hinge. At the same time, rearwardly salient projection 8 engages between side walls 7 of rearwardly adjacent chain link 2 and prevents a mutual lateral displacement of chain links 2. A mutual vertical displacement of chain links 2 is prevented by protrusion 9 of adjacent chain link 2 that is received in rounded portion 10, on one hand, and on the other hand, by two noses 13 that are connected to raised portion 16 and are resting on web 12 of adjacent chain link 2.

Chain 1 cannot be bent or deflected upwards from the unbent position shown in FIG. 1 since the rearward end edge 19 of a chain link 2 abuts to the front end edge 20 of adjoining chain link 2 when chain links 2 are lined up and connected by ball string 3. However, chain 1 can be bent or deflected downwards as shown in FIG. 2. To this end, a conical gap 15 is provided in the bottom area between two respective chain links 2, which is formed by a taper 14 of side wall 7. Likewise, projection 8 has a taper on the inside of side wall 7 that leaves room for the projection 8 of the adjoining chain link 2.

When chain 1 is mounted in a screen device that covers or uncovers an opening such as a window by a textile fabric such as an insect screen, the chain links are guided by their sides located at the top in the Figures in a guiding profile while the textile fabric extends between the side walls 7 of chain links 2 in the area at the bottom of FIG. 5 where it is laterally retained and guided.

### LIST OF REFERENCE NUMERALS

1 chain
2 chain link
3 ball string
4 string
5 balls
6 opening
7 side wall
8 projection
9 protrusion
10 rounded portion
11 overhang
12 web
13 nose
14 taper
15 gap
16 raised portion
17 taper
18 slot
19 end edge
20 end edge

1. A chain for a screen device, consisting of a plurality of rigid chain links and of a flexible traction means that connects the chain links, wherein said flexible traction means is a ball string that consists of a string and of balls arranged thereon at intervals, wherein said balls are received in openings of the chain links, and wherein two opposite, unilaterally open slots are provided in the circumference of each opening.

2. The chain of claim 1, wherein said chain link has at least two openings.

3. The chain of claim 1, wherein said chain link has a protrusion on one side and a concave rounded portion on the opposite side in which the protrusion of an adjacent chain link engages.

4. The chain of claim 1, wherein said chain link has two side walls that are connected by a web, and forms an H shape in cross-section.

5. The chain of claim 1, wherein said openings are arranged in said web.

6. The chain of claim 1, wherein projections are provided on the inside of the side walls of said chain link which engage between the side walls of an adjacent chain link.

7. The chain of claim 1, wherein at least one nose is connected to said web, which comes to rest on the web of an adjacent chain link when said chain is unbent.
